(19) United States
(12) Patent Application Publication
(10) Pub. No.: US 2018/0020356 A1
(43) Pub. Date: Jan. 18, 2018

(54) METHOD, APPARATUS AND SYSTEM

(71) Applicant: NOKIA SOLUTIONS AND NETWORKS OY, Espoo (FI)

(72) Inventors: Xubo GU, Shanghai (CN); Jiang WANG, Shanghai (CN); Jing XU, Shanghai (CN); Yong TENG, Beijing (CN); Kari Veikko HORNEMAN, Oulu (FI)

(73) Assignee: NOKIA SOLUTIONS AND NETWORKS OY, Espoo (FI)

(21) Appl. No.: 15/545,654

(22) PCT Filed: Jan. 29, 2015
(86) PCT No.: PCT/CN2015/071856

§ 371 Date: Jul. 21, 2017

(51) Int. Cl. H04W 16/06; H04W 16/32; H04W 16/14

(52) U.S. Cl. CPC H04W 16/06; H04W 16/14; H04W 16/32

(57) ABSTRACT

There is provided a method including determining, at a first neighbour node of a spectrum sharing group of nodes, initial cost information for sharing spectrum with an acting node in said group in dependence on node parameters associated with the first neighbour node, causing the initial cost information to be sent the acting node, determining final cost information in dependence on received cost information associated with at least one second node neighbour of the group, the received cost information determined in dependence on parameters associated with the least one second neighbour node and causing the final cost information to be sent to the acting node.

### BACKGROUND

The present application relates to a method, apparatus and system and in particular but not exclusively, to co-primary spectrum sharing.

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communications may comprise, for example, communication of data for carrying communications such as voice, electronic mail (email), text message, multimedia and/or content data and so on. Non-limiting examples of services provided include two-way or multi-way calls, data communication or multimedia services and access to a data network system, such as the Internet.

In a wireless communication system at least a part of communications between at least two stations occurs over a wireless link. Examples of wireless systems include public land mobile networks (PLMN), satellite based communication systems and different wireless local networks, for example wireless local area networks (WLAN). The wireless systems can typically be divided into cells, and are therefore often referred to as cellular systems.

A user can access the communication system by means of an appropriate communication device or terminal. A communication device of a user is often referred to as user equipment (UE). A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. An example of attempts to solve the problems associated with the increased demands for capacity is an architecture that is known as the long-term evolution (LTE) of the Universal Mobile Telecommunications System (UMTS) radio-access technology. The LTE is being standardized by the 3rd Generation Partnership Project (3GPP). The various development stages of the 3GPP LTE specifications are referred to as releases.

### SUMMARY

In a first aspect there is provided a method comprising determining, at a first neighbour node of a spectrum sharing group of nodes, initial cost information for sharing spectrum with an acting node in said group in dependence on node parameters associated with the first neighbour node, causing said initial cost information to be sent the acting node, determining final cost information in dependence on received cost information associated with at least one second node neighbour of said group, said received cost information determined in dependence on parameters associated with the least one second neighbour node; and causing said final cost information to be sent to the acting node.

Said node parameters may comprise at least one of load, spectral efficiency, spectrum bandwidth, an operator flag and number of nodes in the spectrum sharing group.

The method may comprise determining spectrum information, said spectrum information indicating spectrum frequency bandwidths associated with the first neighbour node available for sharing with the acting node and causing an indication of said available spectrum frequency bandwidths to be sent to the acting node.

Said cost information may comprise a comprehensive price indication for sharing spectrum with the neighbour node.

The method may comprise determining said final cost information using an iterative game process.

In a second aspect there is provided a method comprising receiving, at a first node, cost information associated with each of a plurality of nodes of a spectrum sharing group of nodes, said cost information determined in dependence on associated node parameters and cost information for transmitting using spectrum associated with each node of the spectrum sharing group of nodes and determining a node for spectrum sharing from the spectrum sharing group, in dependence on said cost information.

The method may comprise determining performance information for each node of the plurality of nodes.

Performance information may comprise spectral efficiency information for transmitting using spectrum associated with the respective node.

The method may comprise determining a node for spectrum sharing in dependence on an overload parameter if said first node is associated with a first operator and at least one of the plurality of nodes of the spectrum sharing group is associated with a second operator.

The cost information may include spectrum information, said spectrum information indicating spectrum frequency bandwidths associated with the respective one of the plurality of nodes of the spectrum sharing group for sharing with the first node.

The cost information may be determined using an iterative game process.

The cost information may comprise a comprehensive price indication.

Said node parameters may comprise at least one of load, spectral efficiency, spectrum bandwidth, an operator flag and number of nodes in the spectrum sharing group.

In a third aspect there is provided an apparatus, said apparatus comprising means for determining, at a first neighbour node of a spectrum sharing group of nodes, initial cost information for sharing spectrum with an acting node in said group in dependence on node parameters associated with the first neighbour node, means for causing said initial cost information to be sent the acting node, means for determining final cost information in dependence on received cost information associated with at least one second node neighbour of said group, said received cost information determined in dependence on parameters associated with the least one second neighbour node; and means for causing said final cost information to be sent to the acting node.

Said node parameters may comprise at least one of load, spectral efficiency, spectrum bandwidth, an operator flag and number of nodes in the spectrum sharing group.

The apparatus may comprise means for determining spectrum information, said spectrum information indicating spectrum frequency bandwidths associated with the first neighbour node available for sharing with the acting node and causing an indication of said available spectrum frequency bandwidths to be sent to the acting node.

Said cost information may comprise a comprehensive price indication for sharing spectrum with the neighbour node.

The apparatus may comprise means for determining said final cost information using an iterative game process.

In a fourth aspect there is provided an apparatus, said apparatus comprising means for receiving, at a first node, cost information associated with each of a plurality of nodes of a spectrum sharing group of nodes, said cost information determined in dependence on associated node parameters and cost information for transmitting using spectrum associated with each node of the spectrum sharing group of nodes and means for determining a node for spectrum sharing from the spectrum sharing group, in dependence on said cost information.

The apparatus may comprise means for determining performance information for each node of the plurality of nodes.

Performance information may comprise spectral efficiency information for transmitting using spectrum associated with the respective node.

The apparatus may comprise means for determining a node for spectrum sharing in dependence on an overload parameter if said first node is associated with a first operator and at least one of the plurality of nodes of the spectrum sharing group is associated with a second operator.

The cost information may include spectrum information, said spectrum information indicating spectrum frequency bandwidths associated with the respective one of the plurality of nodes of the spectrum sharing group for sharing with the first node.

The cost information may be determined using an iterative game process.

The cost information may comprise a comprehensive price indication.

Said node parameters may comprise at least one of load, spectral efficiency, spectrum bandwidth, an operator flag and number of nodes in the spectrum sharing group.

In a fifth aspect there is provided an apparatus comprising at least one processor and at least one memory including a computer program code, the at least one memory and the computer program code configured to, with the at least one processor, cause the apparatus at least to: determine, at a first neighbour node of a spectrum sharing group of nodes, initial cost information for sharing spectrum with an acting node in said group in dependence on node parameters associated with the first neighbour node, cause said initial cost information to be sent the acting node, determine final cost information in dependence on received cost information associated with at least one second node neighbour of said group, said received cost information determined in dependence on parameters associated with the least one second neighbour node; and cause said final cost information to be sent to the acting node.

Said node parameters may comprise at least one of load, spectral efficiency, spectrum bandwidth, an operator flag and number of nodes in the spectrum sharing group.

The apparatus may be configured to determine spectrum information, said spectrum information indicating spectrum frequency bandwidths associated with the first neighbour node available for sharing with the acting node and causing an indication of said available spectrum frequency bandwidths to be sent to the acting node.

Said cost information may comprise a comprehensive price indication for sharing spectrum with the neighbour node.

The apparatus may be configured to determine said final cost information using an iterative game process.

In a sixth aspect there is provided an apparatus comprising at least one processor and at least one memory including a computer program code, the at least one memory and the computer program code configured to, with the at least one processor, cause the apparatus at least to: receive, at a first node, cost information associated with each of a plurality of nodes of a spectrum sharing group of nodes, said cost information determined in dependence on associated node parameters and cost information for transmitting using spectrum associated with each node of the spectrum sharing group of nodes and determine a node for spectrum sharing from the spectrum sharing group, in dependence on said cost information.

The apparatus may be configured to determine performance information for each node of the plurality of nodes.

Performance information may comprise spectral efficiency information for transmitting using spectrum associated with the respective node.

The apparatus may be configured to determine a node for spectrum sharing in dependence on an overload parameter if said first node is associated with a first operator and at least one of the plurality of nodes of the spectrum sharing group is associated with a second operator.

The cost information may include spectrum information, said spectrum information indicating spectrum frequency bandwidths associated with the respective one of the plurality of nodes of the spectrum sharing group for sharing with the first node.

The cost information may be determined using an iterative game process.

The cost information may comprise a comprehensive price indication.

Said node parameters may comprise at least one of load, spectral efficiency, spectrum bandwidth, an operator flag and number of nodes in the spectrum sharing group.

In a seventh aspect there is provided a computer program embodied on a non-transitory computer-readable storage medium, the computer program comprising program code for controlling a process to execute a process, the process comprising determining, at a first neighbour node of a spectrum sharing group of nodes, initial cost information for sharing spectrum with an acting node in said group in dependence on node parameters associated with the first neighbour node, causing said initial cost information to be sent the acting node, determining final cost information in dependence on received cost information associated with at least one second node neighbour of said group, said received cost information determined in dependence on parameters associated with the least one second neighbour node; and causing said final cost information to be sent to the acting node.

Said node parameters may comprise at least one of load, spectral efficiency, spectrum bandwidth, an operator flag and number of nodes in the spectrum sharing group.

The process may comprise determining spectrum information, said spectrum information indicating spectrum frequency bandwidths associated with the first neighbour node available for sharing with the acting node and causing an indication of said available spectrum frequency bandwidths to be sent to the acting node.

Said cost information may comprise a comprehensive price indication for sharing spectrum with the neighbour node.

The process may comprise determining said final cost information using an iterative game process.

In an eighth aspect there is provided a computer program embodied on a non-transitory computer-readable storage medium, the computer program comprising program code for controlling a process to execute a process, the process comprising receiving, at a first node, cost information associated with each of a plurality of nodes of a spectrum sharing group of nodes, said cost information determined in dependence on associated node parameters and cost information for transmitting using spectrum associated with each node of the spectrum sharing group of nodes and determining a node for spectrum sharing from the spectrum sharing group, in dependence on said cost information.

The process may comprise determining performance information for each node of the plurality of nodes.

Performance information may comprise spectral efficiency information for transmitting using spectrum associated with the respective node.

The process may comprise determining a node for spectrum sharing in dependence on an overload parameter if said first node is associated with a first operator and at least one of the plurality of nodes of the spectrum sharing group is associated with a second operator.

The cost information may include spectrum information, said spectrum information indicating spectrum frequency bandwidths associated with the respective one of the plurality of nodes of the spectrum sharing group for sharing with the first node.

The cost information may be determined using an iterative game process.

The cost information may comprise a comprehensive price indication.

Said node parameters may comprise at least one of load, spectral efficiency, spectrum bandwidth, an operator flag and number of nodes in the spectrum sharing group.

In a ninth aspect there is provided a computer program product for a computer, comprising software code portions for performing the steps of any one of the first and second aspects when said product is run on the computer.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows a schematic diagram of an example communication system comprising a base station and a plurality of communication devices;

FIG. 2 shows a schematic diagram, of an example mobile communication device;

FIG. 3 shows a wireless system having N nodes in an area;

FIG. 4 shows a schematic diagram of a shared spectrum in an inter-operator scenario;

FIG. 5 shows a schematic diagram of a shared spectrum in an intra-operator scenario;

FIG. 6a shows a flow chart of an example method of a spectrum sharing mechanism;

FIG. 6b shows a flow chart of an example method of a spectrum sharing mechanism;

FIG. 7 shows a flow chart of an example method of a spectrum sharing mechanism;

FIG. 8 shows a flow chart of an example iterative cost determination process;

FIG. 9 shows an example control apparatus;

FIG. 10 shows an example apparatus;

FIG. 11 shows an example apparatus;

### DETAILED DESCRIPTION

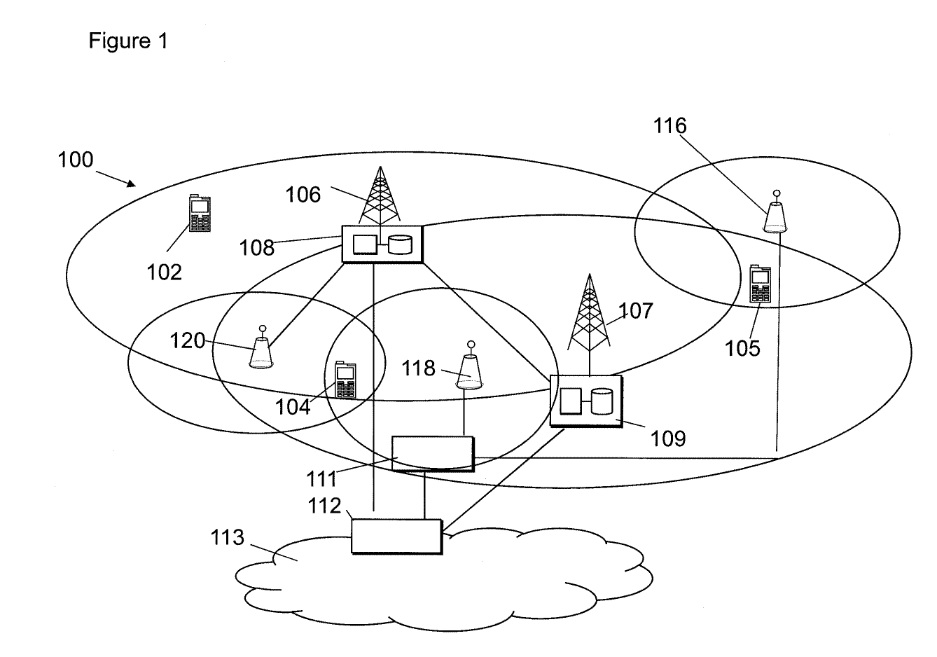

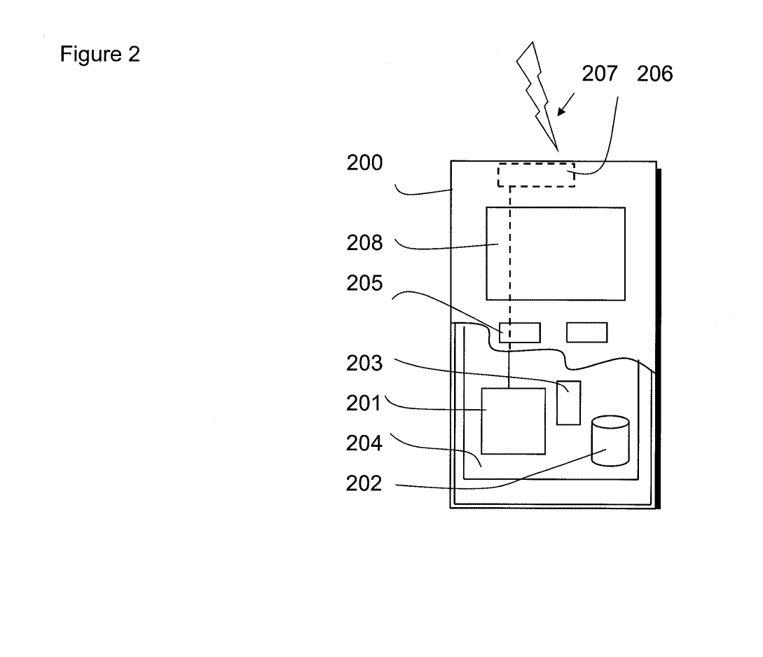

Before explaining in detail the examples, certain general principles of a wireless communication system and mobile communication devices are briefly explained with reference to FIGS. 1 to 2 to assist in understanding the technology underlying the described examples.

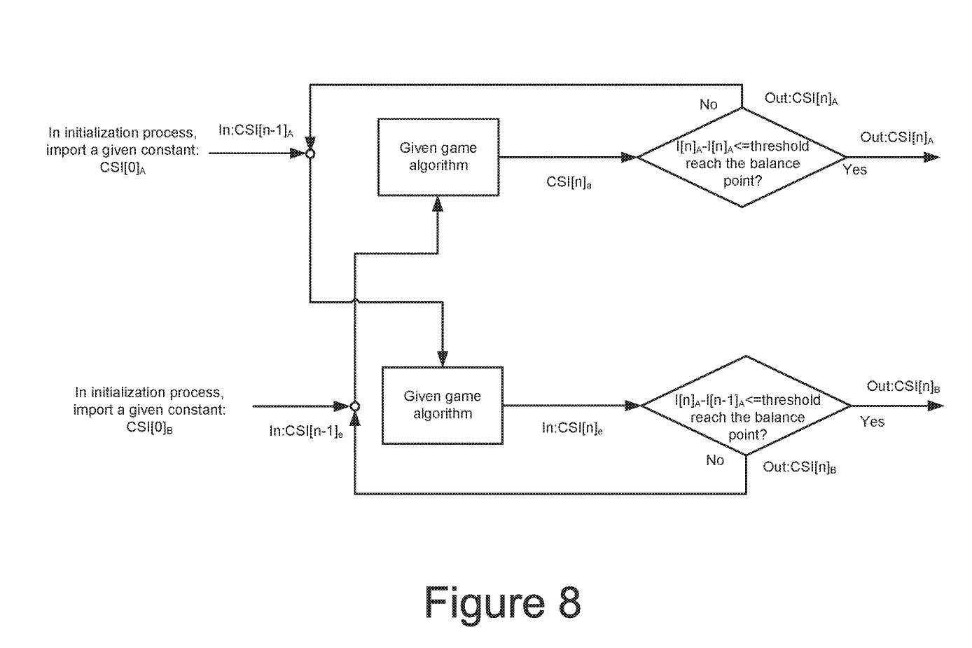

In a wireless communication system 100, such as that shown in FIG. 1, mobile communication devices or user equipment (UE) 102, 104, 105 are provided wireless access via at least one base station or similar wireless transmitting and/or receiving node or point. Base stations are typically controlled by at least one appropriate controller apparatus, so as to enable operation thereof and management of mobile communication devices in communication with the base stations. The controller apparatus may be located in a radio access network (e.g. wireless communication system 100) or in a core network (not shown) and may be implemented as one central apparatus or its functionality may be distributed over several apparatus. The controller apparatus may be part of the base station and/or provided by a separate entity such as a Radio Network Controller. In FIG. 1 control apparatus 108 and 109 are shown to control the respective macro level base stations 106 and 107. The control apparatus of a base station can be interconnected with other control entities. The control apparatus is typically provided with memory capacity and at least one data processor. The control apparatus and functions may be distributed between a plurality of control units. In some systems, the control apparatus may additionally or alternatively be provided in a radio network controller. The control apparatus may provide an apparatus such as that discussed in relation to FIG. 8.

LTE systems may however be considered to have a so-called “flat” architecture, without the provision of RNCs; rather the (e)NB is in communication with a system architecture evolution gateway (SAE-GW) and a mobility management entity (MME), which entities may also be pooled meaning that a plurality of these nodes may serve a plurality (set) of (e)NBs. Each UE is served by only one MME and/or S-GW at a time and the (e)NB keeps track of current association. SAE-GW is a “high-level” user plane core network element in LTE, which may consist of the S-GW and the P-GW (serving gateway and packet data network gateway, respectively). The functionalities of the S-GW and P-GW are separated and they are not required to be co-located.

In FIG. 1 base stations 106 and 107 are shown as connected to a wider communications network 113 via gateway 112. A further gateway function may be provided to connect to another network.

The smaller base stations 116, 118 and 120 may also be connected to the network 113, for example by a separate gateway function and/or via the controllers of the macro level stations. The base stations 116, 118 and 120 may be pico or femto level base stations or the like. In the example, stations 116 and 118 are connected via a gateway 111 whilst station 120 connects via the controller apparatus 108. In some embodiments, the smaller stations may not be provided.

A possible mobile communication device will now be described in more detail with reference to FIG. 2 showing a schematic, partially sectioned view of a communication device 200. Such a communication device is often referred to as user equipment (UE) or terminal. An appropriate mobile communication device may be provided by any device capable of sending and receiving radio signals. Non-limiting examples include a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services include two-way or multi-way calls, data communication or multimedia services or simply an access to a data communications network system, such as the Internet. Users may also be provided broadcast or multicast data. Non-limiting examples of the content include downloads, television and radio programs, videos, advertisements, various alerts and other information.

The mobile device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

A mobile device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

The communication devices 102, 104, 105 may access the communication system based on various access techniques, such as code division multiple access (CDMA), or wideband CDMA (WCDMA). Other non-limiting examples comprise time division multiple access (TDMA), frequency division multiple access (FDMA) and various schemes thereof such as the interleaved frequency division multiple access (IFDMA), single carrier frequency division multiple access (SC-FDMA) and orthogonal frequency division multiple access (OFDMA), space division multiple access (SDMA) and so on.

An example of wireless communication systems are architectures standardized by the 3rd Generation Partnership Project (3GPP). A latest 3GPP based development is often referred to as the long term evolution (LTE) of the Universal Mobile Telecommunications System (UMTS) radio-access technology. The various development stages of the 3GPP specifications are referred to as releases. More recent developments of the LTE are often referred to as LTE Advanced (LTE-A). The LTE employs a mobile architecture known as the Evolved Universal Terrestrial Radio Access Network (E-UTRAN). Base stations of such systems are known as evolved or enhanced Node Bs (eNBs) and provide E-UTRAN features such as user plane Radio Link Control/Medium Access Control/Physical layer protocol (RLC/MAC/PHY) and control plane Radio Resource Control (RRC) protocol terminations towards the communication devices. Other examples of radio access system include those provided by base stations of systems that are based on technologies such as wireless local area network (WLAN) and/or WiMax (Worldwide Interoperability for Microwave Access). A base station can provide coverage for an entire cell or similar radio service area.

The embodiments are not, however, restricted to the system given as an example but a person skilled in the art may apply the solution to other communication systems provided with necessary properties.

Another example of a suitable communications system is the 5G concept. It is assumed that network architecture in 5G will be quite similar to that of the LTE-advanced. 5G is likely to use multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates. 5G will likely be comprised of more than one radio access technology (RAT), each optimized for certain use cases and/or spectrum.

It should be appreciated that future networks will most probably utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations to be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent. Some other technology advancements probably to be used are Software-Defined Networking (SDN), Big Data, and all-IP, which may change the way networks are being constructed and managed.

In traditional spectrum resource allocation, spectrum allocation is fixed. This method may be easy to implement and the interference level between each base station (BS) may be low. However, some BSs' spectrum may be exhausted because of increasing access users and/or some BSs' spectrum may be idle because of reduced access users. Traditional fixed spectrum allocation may lead to a waste of spectrum resource and/or low spectrum efficiency.

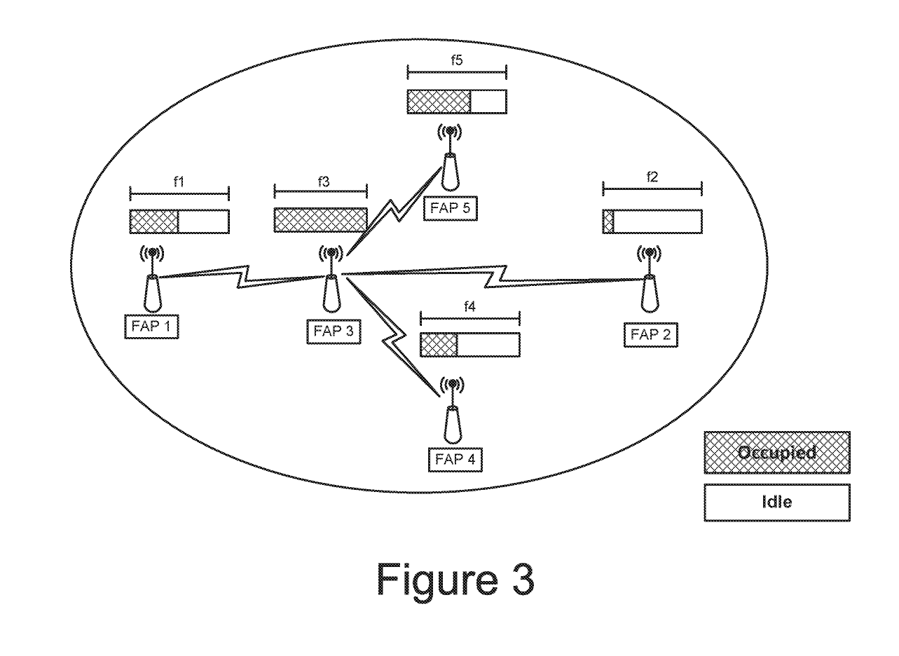

Dynamic spectrum allocation (DSA) is one spectrum resource allocation method. A co-primary spectrum sharing scenario is considered below and illustrated in FIG. 3.

A simple model of DSA is that Operators constitute a common spectrum sharing pool, Operators share the same spectrum with dedicated spectrum band for each Operator or with spectrum pool basis or with combination. For example, in an exclusive licensed spectrum scenario a mobile network operator (MNO) gets rights to use the spectrum band in its networks without sharing it with other MNOs' networks. Base stations (BSs) belonging to different MNOs' networks do not share spectrum with each other but within one MNO's network there may be a generally used single frequency scheme in which the same spectrum band is reused in neighbouring BSs. The allocated band for each Operator may depend on some related parameters such as load, signal noise ratio (SNR) and so on. In a dense deployment scenario, the coexistence of multiple Operators in adjacent or same areas may be common. Dynamic frequency management is considered to be beneficial to improve the spectrum efficiency in LTE-A heterogeneous networks.

At present, in some DSA mechanisms, when a BS is overloaded and needs more spectrum resource, the centre controller may reallocate the spectrum among nodes according to a centralized allocation algorithm. However, considering the situation of dense deployment of the BS, the BSs may be overloaded and trigger the centre controller often, so the reallocation process may takes place frequently. Frequent spectrum reallocation may introduce signaling waste and lead to low spectrum efficiency.

Many DSA mechanisms are established under intra-operator scenario (build an intra-operator spectrum pool and BSs share spectrum in the pool respectively according to traffic load or demand). In an intra-operator scenario, load or status information is not sensitive among BSs. This information may be easily exchanged among BSs and the spectrum sharing process may be simple to implement. However, considering the factors of load balance or the size of spectrum sharing pool etc., the intra-operator spectrum sharing performance gain may be limited. The performance gain of intra-operator spectrum sharing may not be sufficient to satisfy the increasing demand of spectrum resource.

FIG. 3 illustrates a wireless system having N nodes in an area. In this example, the nodes are Femtocell Access Points (FAPs). The nodes belong to different Operators (e.g. Operator A: FAP 1,2,3; Operator B: FAP 4,5). Each FAP has a pre-assigned spectrum resource (f1-f5). At least a portion of the spectrum may be occupied. The portion of the spectrum that is not occupied may be referred to as idle. It is assumed in this example that each FAP is willing to share their spectrum with each other in the situation when their own users' QoS (Quality of Service) has been satisfied. Each node in the network may be seen as an acting node, which is able to build a virtual group with its neighbor nodes (the neighbor nodes may contain both intra-operator and inter-operator nodes). In this virtual group, the nodes' spectrum resource constitute a spectrum sharing pool. When the acting node is overloaded, it may share the neighbor's spectrum according to a given rule. In the following examples, explained with reference to FIG. 3, FAP 3 is an acting node. When FAP3 is overloaded, it may utilize an adaptive sharing mechanism to share the neighbors' spectrum resource to satisfy its spectrum demand.

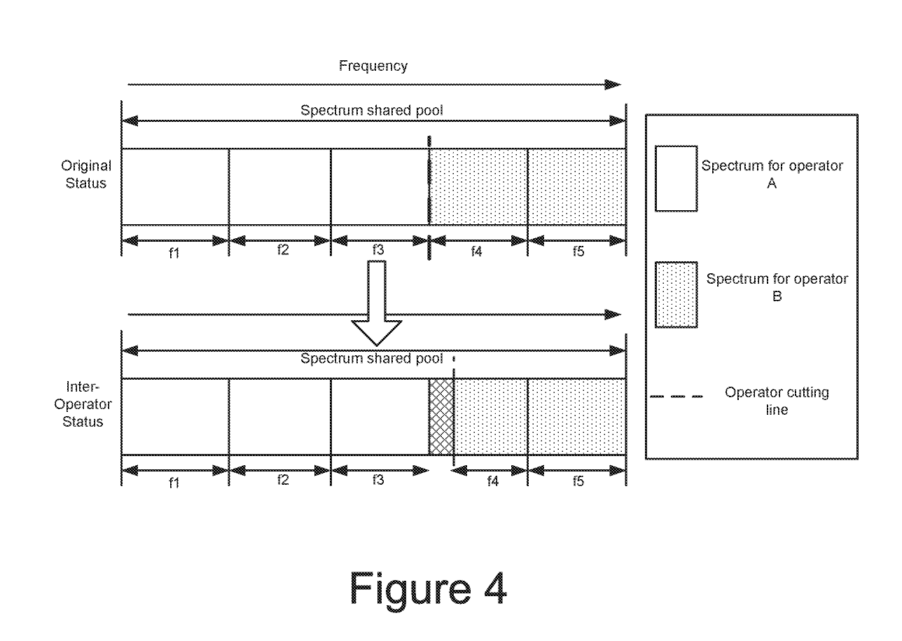

A first case is shown in FIG. 4. When the acting node (FAP 3) is overloaded, FAP 4 (or FAP 5) is selected to be the most suitable BS for FAP 3 according to a given algorithm and mechanism. So FAP 3 will occupy some spectrum resource belong to FAP 4 (or FAP 5). The spectrum sharing takes place inter-operator.

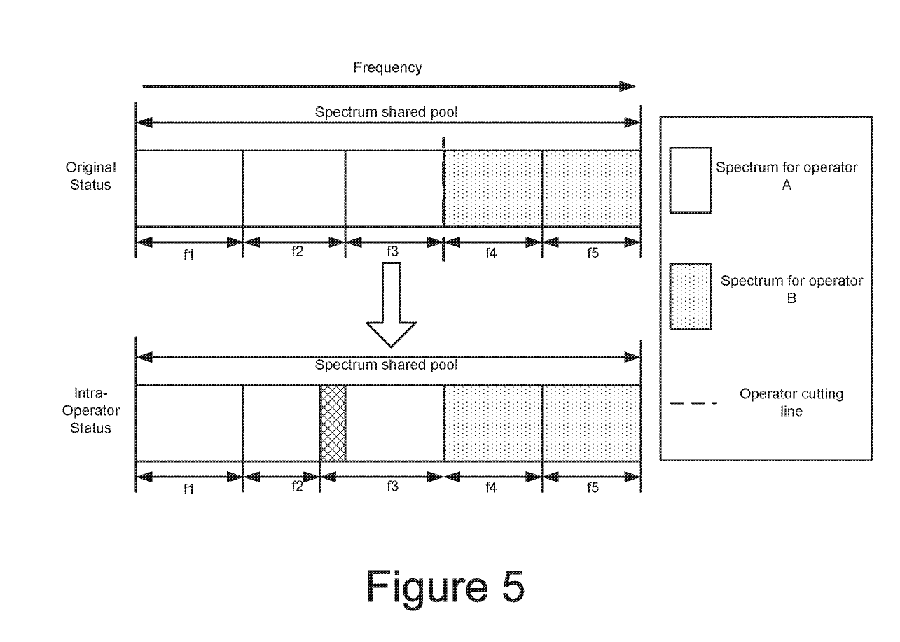

A second case is shown in FIG. 5. When the acting node (FAP 3) is overloaded, FAP 2 (or FAP 1) is selected to be the most suitable BS for FAP 3 according to the given algorithm and mechanism. So FAP 3 will occupy some spectrum resource belongs to FAP 2 (or FAP 1). The spectrum sharing process takes place intra-operator.

The spectrum sharing process may be more flexible and the spectrum sharing pool may be bigger under an inter-operator scenario, such that the corresponding spectrum efficiency and/or performance gain may improve. However, the related sharing mechanism may be more complex and difficult. Besides the selection of the most suitable BS, information exchange among BSs of different operators may be problematic. In an inter-operator scenario, the information exchange among BSs may not be as complete and transparent since it may not be desirable for some sensitive information (such as amount of users, bandwidth, etc.) to be exchanged directly during the spectrum sharing mechanism.

Some DSA methods including centralized and distributed approaches have been suggested. These methods may allocate and manage the spectrum resource, when a BS's spectrum is exhausted, according to a centralized or distributed algorithm in the region. In the deployment scenario of macro BS, the amount and load of each macro BS's users may be relatively stable, the reallocation process will not take place frequently, so the method may improve spectrum efficiency. However, in the dense deployment scenario of femtocell BS, the frequent reallocation process may bring high signaling overheads and low working efficiency of the BS.

Spectrum allocation algorithms based on game theory have been proposed in which BSs are divided into primary and secondary BSs. Secondary BSs can share primary BS's spectrum according to a related game algorithm. In this scenario, the relationship among the BSs is unequal, primary BSs are dominant in the process. This may lead to limitations in the sharing process and may decrease the spectrum efficiency.

Inter-operator spectrum and network sharing for IMT-A systems have been proposed, including a framework for the integration of functionalities for dynamic spectrum use. In this framework, a center controller such as cooperative RRM or spectrum manager is required to manage the spectrum resource and adjust spectrum allocation dynamically according to related measurement information. Including a centralized scheduler between each Operator may increase the complexity of the system.

A method which provides UEs the right to select its own connection among Operators according to queue analysis and robust potential game algorithm has been proposed. Through the selection mechanism, UEs may choose their optimal connection and improve global spectrum efficiency. However, because the selection calculation is done in UEs, this may increase the burden of terminals. UEs may access arbitrary connection so that there is difference among different Operators' BSs, so such a selection mechanism may be difficult to realize in an inter-operator system.

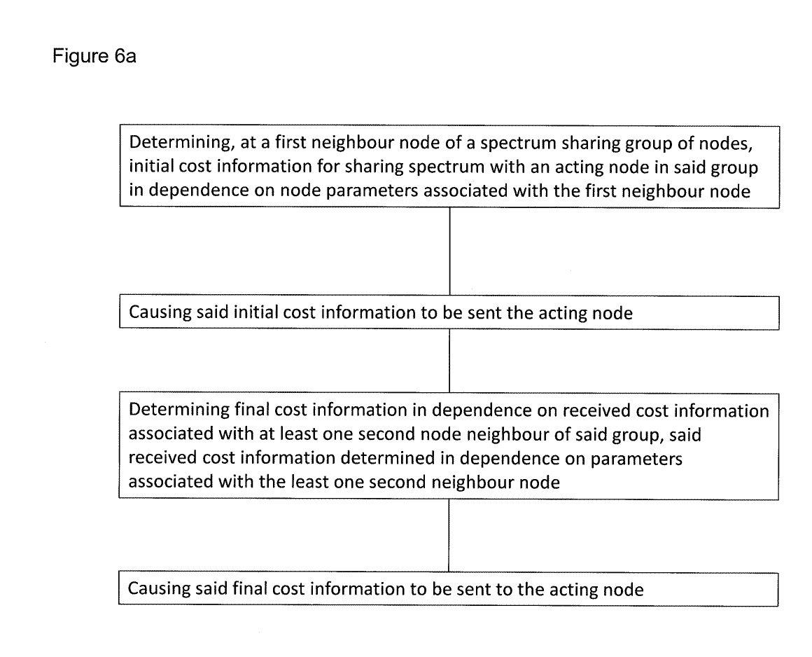

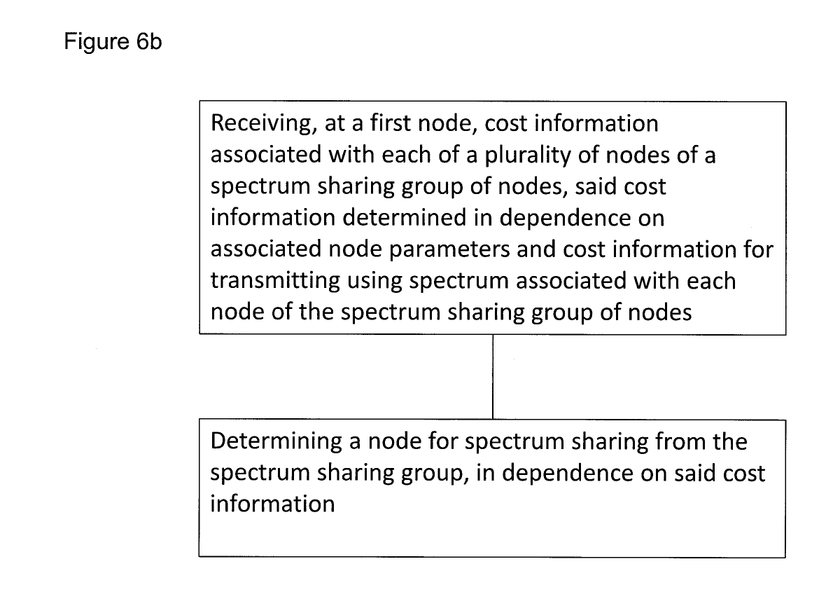

FIG. 6a shows a flow chart of an example spectrum sharing method. The method comprises, in a first step, determining, at a first neighbour node of a spectrum sharing group of nodes, initial cost information for sharing spectrum with an acting node in said group in dependence on node parameters associated with the first neighbour node. In a second step, the method comprises causing said initial cost information to be sent the acting node. In a third step the method comprises determining final cost information in dependence on received cost information associated with at least one second neighbour node of said group, said received cost information determined in dependence on parameters associated with the least one second neighbour node and, in a fourth step, causing said final cost information to be sent to the acting node.

FIG. 6b shows a flow chart of an example spectrum sharing method. The method comprises receiving, at a first node, cost information associated with each of a plurality of nodes of a spectrum sharing group of nodes, said cost information determined in dependence on associated node parameters and cost information for transmitting using spectrum associated with each node of the spectrum sharing group of nodes and determining a node for spectrum sharing from the spectrum sharing group, in dependence on said cost information.

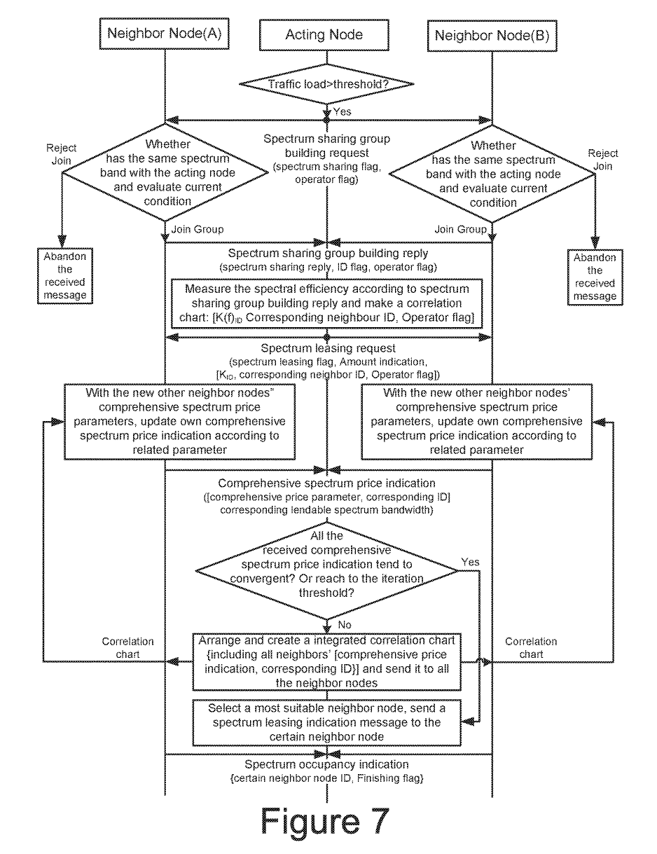

A detailed implementation flowchart for an example model with an acting node and two neighbour nodes is shown in FIG. 7. A detailed example implementation of the method shown in FIGS. 6a, 6b and 7 can be described as follows:

The method may comprise building the spectrum sharing group of nodes. Based on current neighbour relationship and topology, a virtual spectrum sharing group may be built and the number of neighbour nodes in the group determined. The acting node may broadcast a Spectrum sharing group building Request message to all its neighbour nodes. The acting node may detect the replies from neighbour nodes within a period set by a timer. After the acting node sends the request, the timer may begin. In this time window, the acting node detects the replies from neighbour nodes.

The Spectrum sharing group Building Request message may comprise at least an operator flag, a spectrum sharing flag and an owned spectrum band. The operator flag indicates which Operator the acting node belongs to. The spectrum sharing flag requests neighbour nodes join the spectrum sharing group.

The Spectrum sharing group Building Request message is sent from acting node to neighbour nodes.

After all neighbour nodes receive the Spectrum sharing group building Request message, they firstly judge whether they have the same spectrum band with the acting node. If the spectrum band is not overlapped, then neighbour nodes will evaluate their condition respectively and make a decision whether or not join the group. If the neighbour node wants to join the group, it sends a Spectrum sharing group building Reply message to the acting node.

The spectrum sharing group building reply message contains a, Spectrum sharing reply, an Operator flag and a Cell ID. The spectrum sharing reply indicates whether the neighbour node will join the group or not.

The spectrum sharing group building reply message is sent from neighbour node to acting node.

The acting node detects and receives the Spectrum sharing group building Reply messages. The acting node may stop detecting the reply messages at the end of the timer window.

The acting node may determine performance information for each node of the spectrum sharing group. Determining performance information may comprise the acting node measuring performance information for the at least one second node, e.g. the spectral efficiency of wireless transmission, K(f)_{ID}, with corresponding neighbour ID's frequency spectrum according to received Spectrum sharing group building Reply message.

The collected and detected performance information can be integrated into a correlation chart. As depicted in Table 1, the acting node (FAP 3) integrates related information according to the scenario in FIG. 1.

TABLE 1
Correlation information table

| Operator Flag | Cell ID | K(f)_{ID} |
|---|---|---|
| Operator A | FAP 1 | K(f1)_{FAP1} |
| Operator A | FAP 2 | K(f2)_{FAP2} |
| Operator B | FAP 4 | K(f4)_{FAP4} |
| Operator B | FAP 5 | K(f5)_{FAP5} |

The acting node may then send a Spectrum leasing request message to neighbour nodes in the group.

The Spectrum leasing Request message may contains a Spectrum leasing flag, an Amount indication and a correlation information table.

The spectrum leasing flag indicates that the traffic of the acting node is heavy and the spectrum resource it owned will be exhausted. The amount indication may indicate the amount of the neighbour nodes in the virtual group.

The Spectrum leasing Request message is sent from acting node to neighbour nodes

In on embodiment, determining cost information may comprise determining cost information, e.g. comprehensive spectrum price indication (CPI), for sharing spectrum with the first node, or acting node. For example, when each neighbour node receives the Spectrum leasing request message, it may use a corresponding function to calculate a comprehensive spectrum price with related node parameters. The comprehensive spectrum price indication may be influenced by other neighbour nodes' comprehensive spectrum price indication.

In an initial calculation, a constant is set to replace other neighbour nodes' comprehensive spectrum price indication to calculate each neighbour node's own initialization comprehensive spectrum price indication, or initial cost information.

Each neighbour node sends its initial comprehensive spectrum price indication message to the acting node, the message contains [Comprehensive Price Indication, Cell ID] and corresponding leasable spectrum bandwidth.

After acting node receives the comprehensive spectrum price indication messages from all the neighbour nodes, it creates an integrated comprehensive spectrum price indication table according to received information and sends it to all the neighbour nodes in the virtual group. Initial cost information may be determined in dependence on node parameters associated with that node. Node parameters may comprise any one of, or a combination of, load, spectral efficiency, spectrum bandwidth, an operator flag and the number of nodes in the spectrum sharing group. Each neighbour node repeats the calculation process and updates its own comprehensive spectrum price indication according to other neighbour nodes' changed comprehensive spectrum price indications. The process can be depicted in FIG. 8, through a iteration process, all the neighbour nodes' comprehensive spectrum price indications tend to the balance points and corresponding leasable CC, i.e. available spectrum frequency bandwidths, are determined. To avoid high signaling overloads, an iteration threshold may be set.

An example algorithm to calculate the corresponding CPI of each neighbour node is shown below. The cost function Cᵢ can be defined as in equation 1:

$${C}_{i} ( {b}_{i} ) = {c}_{2} {{M}_{i} ( {B}_{i}^{req} - \frac{{W}_{i} - {b}_{i}}{{M}_{i}} )}^{2} \qquad ( 1 )$$

Where c₂ denotes the constant weight, B^{req} is the bandwidth requirement for a neighbour node's user, Wᵢ is the size of spectrum which a neighbour node owns, Mᵢ is the number of the neighbour node's users, bᵢ is shared spectrum from the neighbour node i.

Equation 2 defines the revenue function, Rᵢ. For neighbor node i, its own revenue is c₁Mᵢ, CPIᵢbᵢ denotes the revenue gained from sharing idle spectrum bᵢ with acting node.

Rᵢ=CPIᵢbᵢ+c₁Mᵢ (2)

The profit function P(p) of neighbor node can be written as in equation 3.

$$𝒫 ( p ) = {R}_{i} - {C}_{i} ( {b}_{i} ) = {CPI}_{i} {b}_{i} + {c}_{1} {M}_{i} - {c}_{2} {{M}_{i} ( {B}_{i}^{req} - \frac{{W}_{i} - {b}_{i}}{{M}_{i}} )}^{2} \qquad ( 3 )$$

Mathematically, to obtain the best response point, we have to solve the following set of equations:

$$\frac{\partial 𝒫 ( p )}{\partial {p}_{i}} = 0$$

for all i. However, equation (3) has two unknowns: CPIᵢ and bᵢ. To realize the game algorithm based on different CPIs, bᵢ should be replaced. Here, we should use the utility function (defined in equation 6) to calculate the equation of bᵢ. According to equation

$$\frac{\partial 𝒫 ( p )}{\partial {p}_{i}} = 0$$

we can obtain the spectrum demand function (equation 4) given the prices of all neighbour nodes. Then replace bᵢ with bᵢ(p) in equation (3) and we can obtain equation (5) by

$$\frac{\partial U ( b )}{\partial {b}_{i}} = 0$$

In equation (5), CPIᵢ denotes the bid of neighbour node i and CPIⱼ (j≠i) denotes the bid of other neighbour nodes. CPIᵢ changes with the change of CPIⱼ. In equation 5, D₂, parameter v is defined to express the degree of freedom when the acting node uses the shared spectrum from neighbor node i, here we can set a constant from 0 to 1. N is the number of nodes in the spectrum sharing group, Kᵢ is the spectral efficiency.

$$\begin{matrix}{b}_{i} ( p ) = \frac{( {k}_{i}^{( s )} - {CPI}_{i} - {t}_{i} ) ( v ( N - 2 ) + 1 ) - v {\sum }_{i \neq j} ( {k}_{j}^{( s )} - {CPI}_{j} - {t}_{j} )}{( 1 - v ) ( v ( N - 1 ) + 1 )} & ( 4 ) \\ 0 = 2 {c}_{2} {D}_{2} ( {B}_{i}^{req} - \frac{{W}_{i} - ( {b}_{1} ( {CPI}_{( j )} ) - {b}_{2} {CPI}_{i} )}{{M}_{i}} ) + {b}_{1} ( {CPI}_{j} ) - 2 {b}_{2} {CPI}_{i} & ( 5 )\end{matrix}$$

(In equation (5),

$${b}_{1} ( {CPI}_{( j )} ) = \frac{{K}_{i}^{( s )} ( v ( N - 2 ) + 1 ) - v {\sum }_{i \neq j} ( {K}_{j}^{( s )} - {CPI}_{j} - {t}_{j} )}{( 1 - , v ) ( v ( N - 1 ) + 1 )}$$

$${b}_{2} = \frac{( v ( N - 2 ) + 1 )}{( 1 - v ) ( v ( N - 1 ) + 1 )}$$

The calculation process above can be seen as a game process, each neighbour node calculates its own comprehensive spectrum price indication with above related parameters (Note that all above parameters are fixed except the other neighbour nodes' comprehensive spectrum price indications. Each node's comprehensive spectrum price indication changed with the change of other neighbour nodes' comprehensive spectrum price indication). In a calculation round, each neighbour calculates its own comprehensive spectrum price indication and sends it to acting node. After acting node receives the comprehensive spectrum price indications from all the neighbours, it arranges the information into an integrated table as shown in table 2 and sends it to all the neighbour nodes. According to the information, each neighbour node updates its comprehensive spectrum price indication in the next calculation round. Through a game and iteration process, all neighbour nodes' comprehensive spectrum price indications tend to the balance points, when their comprehensive spectrum price indications are determined, their respective corresponding leasable CC are determined also (According to equation 4).

TABLE 2
Integrated comprehensive spectrum price indication table

| Cell ID | Comprehensive Price Indication |
|---|---|
| FAP 1 | CPI_{FAP1} |
| FAP 2 | CPI_{FAP2} |
| FAP 4 | CPI_{FAP4} |
| FAP 5 | CPI_{FAP5} |

In an embodiment, determining a node for spectrum sharing from the spectrum sharing group comprises, the acting node using the utility function to calculate utility values according to received comprehensive price indications and corresponding leasable CC. It will select the most suitable node which maximizes utility value. The acting node chooses a most suitable neighbour node according to a utility function and sends a spectrum occupancy indication message to the certain neighbour node.

An example of a utility function to quantify this process is shown in equation 6.

$$U ( b ) = {\sum }_{i = 1}^{N} {b}_{i} {k ( f )}_{i} - \frac{1}{2} ( {\sum }_{i = 1}^{N} {b}_{i}^{2} + 2 v {\sum }_{i \neq j} {b}_{i} {b}_{j} ) - {\sum }_{i = 1}^{N} {CPI}_{i} {b}_{i} - {\sum }_{i = 1}^{N} {b}_{i} {t}_{i} \qquad ( 6 )$$

In this example, spectrum information indicating spectrum available for sharing is denoted by bᵢ. bᵢ denotes the set of shared CC (component carrier) from the neighbor nodes (b={b₁, . . . , bᵢ, . . . , bₙ}). Cost information, or CPIᵢ, is the comprehensive price indication of each neighbour node i. The performance information in this example is k(f)ᵢ representing the spectral efficiency. Parameter v is defined to express the degree of freedom when the acting node using the shared spectrum from neighbor node i, here we can set a constant from 0 to 1.

When the acting node use the spectrum from the neighbor node which belong to a different Operator, it may have some extra overload than when using the neighbor's shared spectrum belong to same Operator (i.e. time and signaling overhead when acting node use the spectrum belong to another Operator or the overheads caused by other related factors). Parameter tᵢ is used to denote the difference of the utility function when the acting node uses the shared spectrum from different neighbors. If the neighbor node belongs to different Operator from the acting node, tᵢ is set to a constant from 0 to 1; If the neighbor node belongs to the same Operator as the acting node, tᵢ=0. bᵢtᵢ presents the extra overload when the acting node use the spectrum belonging to different Operator.

The determined neighbour node receives a spectrum occupancy indication message, it does not use the CC which are occupied by the acting node in lease term. In the situation that the neighbour node is overloaded in the lease term, it may begin a spectrum sharing process with its neighbour nodes also. The spectrum occupancy indication message may include at least one an occupancy flag, a neighbor node ID flag, a lease term and a finishing flag.

It should be understood that each block of the flowchart of FIG. 4 or 5 and any combination thereof may be implemented by various means or their combinations, such as hardware, software, firmware, one or more processors and/or circuitry.

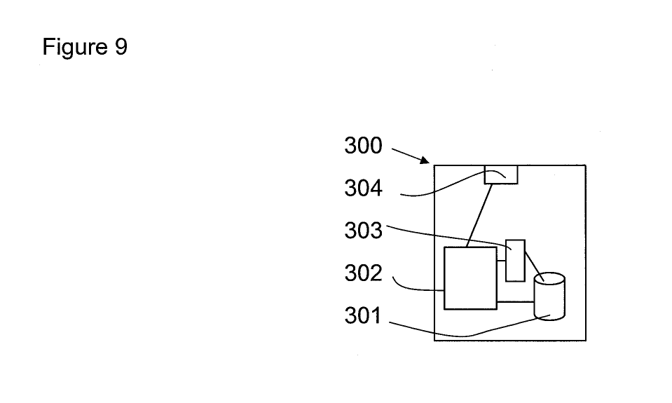

Embodiments described above by means of FIGS. 1 to 8 may be implemented on a control apparatus as shown in FIG. 9 or on a mobile device such as that of FIG. 2. FIG. 9 shows an example of a control apparatus for a communication system, for example to be coupled to and/or for controlling a station of an access system, such as a base station or (e) node B, or a server or host. In some embodiments, base stations comprise a separate apparatus unit or module. In other embodiments, the control apparatus can be another network element such as a radio network controller or a spectrum controller. In some embodiments, each base station may have such a control apparatus as well as a control apparatus being provided in a radio network controller. The control apparatus 300 can be arranged to provide control on communications in the service area of the system. The control apparatus 300 comprises at least one memory 301, at least one data processing unit 302, 303 and an input/output interface 304. Via the interface the control apparatus can be coupled to a receiver and a transmitter of the base station. The receiver and/or the transmitter may be implemented as a radio front end or a remote radio head. For example the control apparatus 300 can be configured to execute an appropriate software code to provide the control functions. Control functions may include at least one of determining, at a first neighbour node of a spectrum sharing group of nodes, initial cost information for sharing spectrum with an acting node in said group in dependence on node parameters associated with the first neighbour node, causing said initial cost information to be sent the acting node, determining final cost information in dependence on received cost information associated with at least one second node neighbour of said group, said received cost information determined in dependence on parameters associated with the least one second neighbour node and causing said final cost information to be sent to the acting node. Alternatively or in addition, control functions may include receiving, at a first node, cost information associated with each of a plurality of nodes of a spectrum sharing group of nodes, said cost information determined in dependence on associated node parameters and cost information for transmitting using spectrum associated with each node of the spectrum sharing group of nodes and determining a node for spectrum sharing from the spectrum sharing group, in dependence on said cost information.

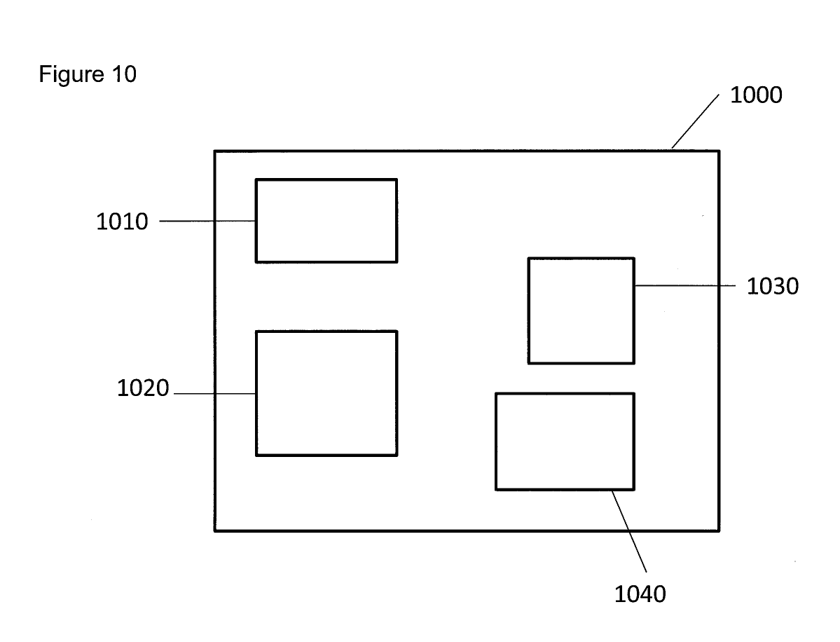

An example of an apparatus 1000 is shown in FIG. 10 and comprises means 1010 for determining, at a first neighbour node of a spectrum sharing group of nodes, initial cost information for sharing spectrum with an acting node in said group in dependence on node parameters associated with the first neighbour node, means 1020 for causing said initial cost information to be sent the acting node, means 1030 for determining final cost information in dependence on received cost information associated with at least one second node neighbour of said group, said received cost information determined in dependence on parameters associated with the least one second neighbour node and means 1040 for causing said final cost information to be sent to the acting node.

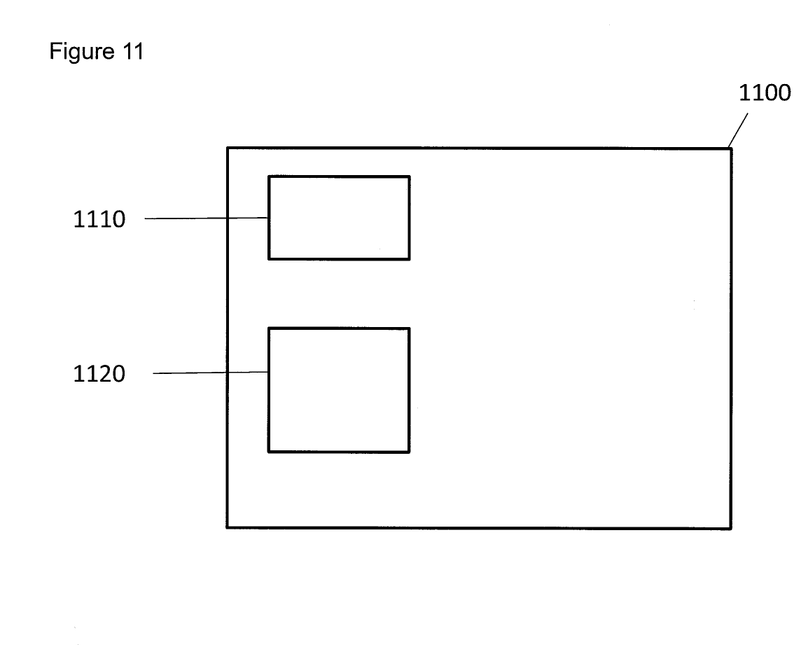

An example of an apparatus 1100 is shown in FIG. 11 and comprises means 1110 for receiving, at a first node, cost information associated with each of a plurality of nodes of a spectrum sharing group of nodes, said cost information determined in dependence on associated node parameters and cost information for transmitting using spectrum associated with each node of the spectrum sharing group of nodes and means 1120 for determining a node for spectrum sharing from the spectrum sharing group, in dependence on said cost information.

It is also noted herein that while the above describes example embodiments, there are several variations and modifications which may be made to the disclosed solution without departing from the scope of the present invention.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments as described above by means of FIGS. 1 to 8 may be implemented by computer software executable by a data processor, at least one data processing unit or process of a device, such as a base station, e.g. eNB, or a UE, in, e.g., the processor entity, or by hardware, or by a combination of software and hardware. Computer software or program, also called program product, including software routines, applets and/or macros, may be stored in any apparatus-readable data storage medium or distribution medium and they include program instructions to perform particular tasks. An apparatus-readable data storage medium or distribution medium may be a non-transitory medium. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), FPGA, gate level circuits and processors based on multi-core processor architecture, as non-limiting examples.

Embodiments described above in relation to FIGS. 1 to 8 may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims. Indeed there is a further embodiment comprising a combination of one or more embodiments with any of the other embodiments previously discussed.

1. A method comprising:
determining, at a first neighbour node of a spectrum sharing group of nodes, initial cost information for sharing spectrum with an acting node in said group in dependence on node parameters associated with the first neighbour node;
causing said initial cost information to be sent the acting node;
determining final cost information in dependence on received cost information associated with at least one second node neighbour of said group, said received cost information determined in dependence on parameters associated with the least one second neighbour node; and
causing said final cost information to be sent to the acting node.

2.-5. (canceled)

6. A method comprising:
receiving, at a first node, cost information associated with each of a plurality of nodes of a spectrum sharing group of nodes, said cost information determined in dependence on associated node parameters and cost information for transmitting using spectrum associated with each node of the spectrum sharing group of nodes; and
determining a node for spectrum sharing from the spectrum sharing group, in dependence on said cost information.

7.-14. (canceled)

15. A computer program product for a computer, comprising software code portions for performing the steps of claim 1 when said product is run on the computer.

16. An apparatus comprising:
at least one processor and at least one memory including a computer program code, the at least one memory and the computer program code configured to, with the at least one processor, cause the apparatus at least to:
determine, at a first neighbour node of a spectrum sharing group of nodes, initial cost information for sharing spectrum with an acting node in said group in dependence on node parameters associated with the first neighbour node;
cause said initial cost information to be sent the acting node;
determine final cost information in dependence on received cost information associated with at least one second node neighbour of said group, said received cost information determined in dependence on parameters associated with the least one second neighbour node; and
cause said final cost information to be sent to the acting node.

17. An apparatus according to claim 16, wherein said node parameters comprise at least one of load, spectral efficiency, spectrum bandwidth, an operator flag and number of nodes in the spectrum sharing group.

18. An apparatus according to claim 16, wherein the computer program code is further configured to cause the apparatus to:
determine spectrum information, said spectrum information indicating spectrum frequency bandwidths associated with the first neighbour node available for sharing with the acting node; and
cause an indication of said available spectrum frequency bandwidths to be sent to the acting node.

19. An apparatus according to claim 16, wherein said cost information comprises a comprehensive price indication for sharing spectrum with the neighbour node.

20. An apparatus according to claim 16, wherein the computer program code is further configured to cause the apparatus to determine the final cost information using an iterative game process.

21. An apparatus comprising:
at least one processor and at least one memory including a computer program code, the at least one memory and the computer program code configured to, with the at least one processor, cause the apparatus at least to:
receive at a first node, cost information associated with each of a plurality of nodes of a spectrum sharing group of nodes, said cost information determined in dependence on associated node parameters and cost information for transmitting using spectrum associated with each node of the spectrum sharing group of nodes; and
determine a node for spectrum sharing from the spectrum sharing group, in dependence on said cost information.

22. An apparatus according to claim 21, wherein the computer program code is further configured to cause the apparatus to determine performance information for each node of the plurality of nodes.

23. An apparatus according to claim 22, wherein the performance information comprises spectral efficiency information for transmitting using spectrum associated with the respective node.

24. An apparatus according to claim 21, wherein said first node is associated with a first operator and at least one of the plurality of nodes of the spectrum sharing group is associated with a second operator, comprising: determining a node for spectrum sharing in dependence on an overload parameter.

25. An apparatus according to claim 21, wherein the cost information includes spectrum information, said spectrum information indicating spectrum frequency bandwidths associated with the respective one of the plurality of nodes of the spectrum sharing group node available for sharing with the first node.

26. An apparatus according to claim 21, wherein the cost information is determined using an iterative game process.

27. An apparatus according to claim 21, wherein the cost information comprises a comprehensive price indication.

28. An apparatus according to claim 21, wherein said node parameters comprise at least one of load, spectral efficiency, spectrum bandwidth, an operator flag and number of nodes in the spectrum sharing group.
